(19) United States
(12) Patent Application Publication
(10) Pub. No.: US 2007/0238083 A1
(43) Pub. Date: Oct. 11, 2007

(54) WIKI-Facilitated Learning Management Process and Apparatus

(75) Inventors: Adam Paul Zamora, Park Ridge, IL (US); Jonathan Mark Gray, Chicago, IL (US); Thomas John Reilly, Glen Ellyn, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Trifus N.A., LLC, Chicago, IL (US)

(21) Appl. No.: 11/539,087

(22) Filed: Oct. 5, 2006

Related U.S. Application Data
(60) Provisional application No. 60/744,481, filed on Apr. 7, 2006.

(51) Int. Cl. G09B 7/00

(52) U.S. Cl. 434/350

(57) ABSTRACT

One provides (101) both a software-based learning management system that maintains and offers defined learning paths and auditable training histories that correspond to e-learning opportunities for specific learners as well as a software-based wikispace that is configured and arranged to permit substantially all visitors to create, edit, and publicly post candidate training content without preauthorization as to content. Specific learners are then allowed to access the wikispace to thereby facilitate development of wiki-based candidate training content, and incorporation of that wiki-based candidate training content is then automatically facilitated as at least one of these e-learning opportunities.

### RELATED APPLICATION

This application claims the benefit of the filing date of U.S. Provisional Application No. 60/744,481 which is hereby incorporated in its entirety herein.

### TECHNICAL FIELD

This invention relates generally to software-based learning management systems.

### BACKGROUND

Software-based learning management systems are known in the art. Such systems typically serve to at least organize an offering of e-learning opportunities and to track interactions with such opportunities by a population of learners. In many cases such systems also serve to themselves retain and/or control access to the corresponding e-learning content itself. In effect, such a system typically comprises both a prescriptive learning path as well as an auditable training history for each learner. Such systems are used, for example, to facilitate training within an enterprise, institution, governmental body, or the like.

Such learning management systems are typically founded upon a notion of control. The content comprising the e-learning opportunities is typically prepared pursuant to a particular program and process that ensures the suitability and relevance of the material for the intended learning audience and often to ensure a given degree of look-and-feel compatibility as well. Accordingly, such systems typically provide a considerable amount of centralized control regarding what is offered via a given system, to whom, for how long, under what conditions or circumstances, and so forth.

While often effective to enable the organized presentation of a wide body of training content and to further permit an organized and controlled use of that material by a consuming population, such systems do not always address all of the needs as may characterize a given application setting. As but one illustration in this regard, the very accoutrements of control that typify such an approach tend to introduce considerable delay between when a need for training on a given topic becomes recognized and when a corresponding e-training opportunity becomes available via the system. Such a delay, in turn, can potentially introduce considerable problems as that interim period represents a time during which a need for educational content is understood and recognized but the content itself remains unavailable and hence the need goes unmet.

Software-based wiki systems are also known in the art. “Wiki” will be understood by those skilled in the art to typically refer to a website or the like that essentially allows any visitor to add, remove, or otherwise edit content at that site (with the term wiki comprising a shortened form of the Hawaiian language expression “wiki wiki” that is commonly used as an adjective to denote something as occurring quickly or fast). The popular Wikipedia website comprises one particularly well known example in this regard. The ease by which multiple users can introduce content and interact with one another in wikispace often renders this approach useful, for example, for collaborative writing.

To date, however, wikispace has not been a useful approach in combination with a learning management system. This comes as no particular surprise; the almost anarchic freedom that attends a wiki approach is quite contrary to the underlying tenants of what makes for a valid, trusted learning management system.

### BRIEF DESCRIPTION OF THE DRAWINGS

The above needs are at least partially met through provision of the wiki-facilitated learning management process and apparatus described in the following detailed description, particularly when studied in conjunction with the drawings, wherein:

FIG. 1 comprises a flow diagram as configured in accordance with various embodiments of the invention; and

FIG. 2 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides both a software-based learning management system that maintains and offers defined learning paths and auditable training histories that correspond to learning opportunities for specific learners as well as a software-based wikispace that is configured and arranged to permit substantially all visitors to create, edit, and publicly post candidate training content without preauthorization as to content. Specific learners are then allowed to access the wikispace to thereby facilitate development of wiki-based candidate training content, and incorporation of that wiki-based candidate training content is then automatically facilitated as at least one of these learning opportunities.

By one approach, if desired, life-cycle categories as pertain at least to the wiki-based candidate training content that becomes incorporated as at least one of the learning opportunities is identified and at least one rule that correlates to a given one of the life-cycle categories is provided. This rule can comprise, for example, at least one action to be taken upon attainment of a given one of the life-cycle categories.

So configured, the power of a wiki approach to rapidly gather and form into a useful form content as pertains to a given topic is effectively combined with the power of a learning management system to ensure the substantive vetting, use, and usage tracking of such content in a training context. Accordingly, useful content can be made available for auditable proscribed purposes in a manner that greatly reduces the time frames that are ordinarily required to achieve such a result.

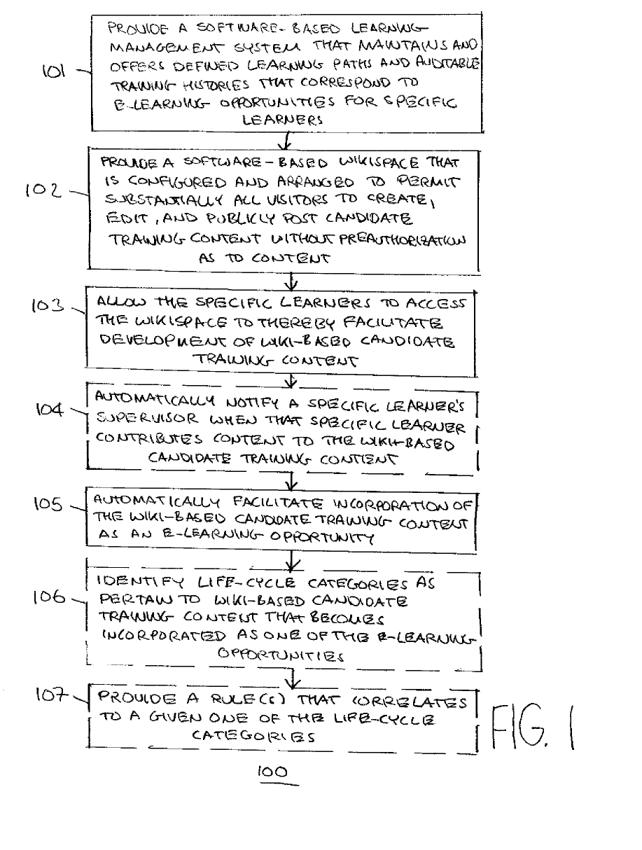

These and other benefits may become clearer upon making a thorough review and study of the following detailed description. Referring now to the drawings, and in particular to FIG. 1, an illustrative process 100 that accords with these teachings provides 101 a software-based learning management system that maintains and offers defined learning paths and auditable training histories that correspond to learning opportunities for specific learners. These specific learners can be affiliated, for example, with a shared enterprise such as, but not limited to, a business, a non-profit enterprise, an academic institution, a union, or other shared affinity organization of choice (including but not limited to associations, clubs, and membership-based groups of various kinds). The learning opportunities can comprise any of a variety of opportunities including classroom-based opportunities, self-study materials, and e-learning opportunities. For the sake of convenience and illustration, the examples provided herein presume the use of e-learning opportunities, but those skilled in the art will understand and recognize that this serves an illustrative purpose only and does not constitute a limitation with respect to the scope of these teachings.

Software-based learning management systems of various kinds are known in the art and others are likely to be developed in the future. As these teachings are not particularly sensitive to the selection of any particular learning management system, for the sake of brevity further elaboration regarding such systems will not be provided here except where particularly relevant to this description. E-learning opportunities are similarly well-understood in the art and can comprise any of a variety of content presentation, assimilation, and/or testing mechanisms. Again, the present teachings are generally applicable for use with all such e-learning opportunities as are presently available or as may be developed going forward. The present teachings will also accommodate using a variety of different e-learning opportunities in a single application setting when such is appropriate or necessary.

This process 100 also provides 102 a software-based wikispace that is configured and arranged to permit substantially all visitors to create, edit, and publicly post candidate training content without preauthorization as to content. By one approach, this wikispace can comprise a browser-based visitor interface (where “browser” will be understood by those skilled in the art as referring generally to a user interface that allows relatively easy navigation among an unspecified number of items as is the case with web browsers that facilitate accessing information on the Internet or a file browser that facilitates accessing information in a file system). The lack of constraints imposed on visitors can further comprise, if desired, a lack of constraints with respect to deleting previously posted materials including previously posted candidate training content.

By one approach, this wikispace can provide search capabilities to permit users to search through one or more databases of content as comprise the wikispace. This can further comprise, if desired, a corresponding index or table of contents to further facilitate a user's ability to locate wiki-content of interest.

By one approach, this wikispace can also optionally automatically search at least one external resource (such as one or more Internet websites, file sharing sites, or other on-line resources) to attempt to identify additional content that may be relevant to publicly posted candidate training content. Such information (and/or a link to such information), once identified, can then be posted in the wikispace in conjunction with the corresponding candidate training content. This can comprise, if desired, posting the information in an order that corresponds to a particular sorting criteria (such as, but not limited to, information regarding the age of the information, alphabetizing, an author of the information, a corresponding rating for the information, and/or an original publisher of the information). This, in turn, can provide further grist to consider for inclusion or use in a resultant e-learning opportunity.

Such wikispaces are well known in the art and the present teachings are again not particularly sensitive to the selection of any particular approach in this regard. Both MediaWiki and Confluence wiki solutions are presently good examples of a useful construct with respect to these teachings though other platforms could certainly be used as well). By one approach, the wikispace can be oriented and/or largely or exclusively directed towards the posting and development of training content. By another approach, however, all or part of the wikispace can be available for the posting of content that is not specifically intended for use as training content and hence does not necessarily constitute candidate training content. In such a case, however, the present teachings will also accommodate later treating and/or using such content as, in fact, candidate training content.

An illustration in the latter regard may be helpful. For example, a first wikispace visitor may create content that notes a problem with a particular internal process. The author's intent may simply be motivated by a wish to warn others of the problem. Over time, however, other visitors may supplement that initial offering with additional content that eventually becomes a reasonably complete explanation regarding the problem, its causes, and available remedies. At this point, the resultant edited content can be viewed as comprising candidate training content that may be useful to disseminate to others on an optional or required basis.

By one approach, candidate training content can be developed using the wikispace in a wholly organic manner. That is, authors can post or modify content simply in pursuit of their own interests. By another approach, however, particular candidate training content can be solicited by, for example, persons responsible for administration of the learning management system. Those skilled in the art will recognize and understand that there are various ways by which such solicitations can be accomplished. In such a case, such an administrator or other responsible party can suggest particular topics of interest and could even organize or arrange for dedicated space within the wikispace to accommodate the development of corresponding candidate training content.

Those skilled in the art will understand that access to such resources as those described above are often controlled in some manner. For example, in many cases a login process will serve to control the makeup of the visiting audience. If desired, these teachings will readily accommodate use of a shared login process for both the learning management system and the wikispace. By this approach, specific learners can access the wikispace without requiring a login process that is separate and discrete from a login process that is required to gain access to the learning management system itself. For example, so configured and arranged, only a single user identity and corresponding password might be required, during a single login activity, to facilitate a user's ability to selectively visit either the learning management system or the wikispace.

As already alluded to above, this process 100 then allows 103 the specific learners to access the wikispace to thereby facilitate development of wiki-based candidate learning content. As used herein, candidate learning content refers in general to learning content that is not yet institutionalized as a specific element of a learning path that is defined, governed, and tracked by the learning management system. By the described approach, members of the e-learning audience are also able to participate in meaningful ways with respect to the creation and/or modification of candidate learning content. So configured, learning content may be formulated without reference, if desired, to particular formats or modes of presentation and without the oversight or intervention of experienced curriculum development personnel. Instead, candidate training content having field-level relevance and practical applicability can be relatively quickly developed and vetted by a viable and vibrant peer review process that lies at the heart of a wiki-based content development process.

If desired, this process 100 will optionally provide for automatic notification 104 of a supervisor of at least one of the specific learners when the at least one of the specific learners contributes content to the wiki-based candidate training content. Such a notification can be based, for example, upon a look-up table that correlates individual specific learners with such a supervisor. As used herein, this reference to “supervisor” will be understood to represent either a direct supervisor or an indirect supervisor including but not limited to supervisors that share their supervisory responsibility with others as in a matrixed supervisory hierarchy. This notification can comprise, for example, information regarding an identity of the specific learner as well as information to facilitate reviewing the content contributed by that specific learner. Such information can comprise, for example, the content itself or some abridged version thereof if desired.

Such a notification, when accommodated, can be provided substantially contemporaneously with the posting or editing of content by the specific learner or, if desired, can be provided at a later time. For example, by one approach, such a notification can be triggered by a certain number of other persons having accessed the content in question or having posted favorable feedback regarding the content in question.

By such an approach, persons presumably in a position to recognize useful training content will be able to remain abreast of wikispace content that might be, or become, useful training content to be made available via the learning management system. This can comprise a relatively passive process where the supervisor simply monitors such content with an eye towards identifying useful content when and as it appears. By another approach, if desired, this can comprise a move active process where the supervisor provides prompts, advice, requests, inspiration, or promises of compensation or other rewards to encourage the further development of the posted content in a particular direction or depth.

In any event, this process 100 can then provide for automatically facilitating incorporation 105 of the wiki-based candidate training content as at least one of the e-learning opportunities that comprise a part of the learning management system. By one approach, this can include providing an opportunity (to, for example, the aforementioned supervisor or other person of interest) to characterize a given item of wiki-based candidate training content as being trackable (via, for example, that learning management system) to one or more defined learning paths. In addition, or in lieu of such an approach, this opportunity can comprise an opportunity to permit a person other than the specific learner who contributed to a given item of wiki-based candidate training content to authorize inclusion of that given item of wiki-based candidate training content in at least one defined learning path as per the learning management system. In such a case, if desired, this step can further comprise providing a notice to specific learners who are associated with that defined learning path of that given item of wiki-based candidate training content. By this approach, such specific learners can learn of a new e-learning opportunity as comprises the wiki-based content that is either generally available or that now comprises a specific requirement for such learners.

So configured and arranged, with the wiki-sourced training content now comprising a part of the learning management system, usage of that training content can now be, for example, tracked for individual specific learners. Such tracking can then be used to ensure that appropriate training is received in a timely manner by persons who will benefit from such training.

As noted, such wiki-based learning content can be incorporated as a part of the learning management system as elective content or as required content for various learners. To support this capability, the aforementioned step of facilitating incorporation of the wiki-based candidate training content as an e-learning opportunity can comprise automatically facilitating incorporation of the wiki-based candidate training content as a required component of at least one of the e-learning opportunities for at least some of the specific learners.

If desired, this process 100 will also accommodate identifying 106 life-cycle categories as pertain at least to the wiki-based candidate training content that becomes incorporated as an e-learning opportunity and to further optionally provide 107 at least one rule that correlates to a given one of those life-cycle categories. Such a rule can comprise, for example, at least one action to be taken upon attainment of the given life-cycle category. Such an action can comprise an automatic action or a non-automatic action, as desired.

As an illustration in this regard, these steps will accommodate establishing a time frame during which the wiki-based candidate training content that has been incorporated into the e-learning opportunity must be reviewed for accuracy. This time frame might comprise, for example, three months, six months, one year, and so forth as best suits the needs and requirements of a given application setting. By one approach such a time frame can comprise a fixed value to be applied in all settings. By another approach this time frame can be selected from amongst a plurality of available time frames. In such a case, these steps will then provide for automatically monitoring for review of the wiki-based content and when that review does not occur within the aforementioned time frame, the content can be, for example, automatically downgraded from incorporation in the e-learning opportunity. This can further comprise, for example, providing a notice in conjunction with presentation of this particular content to a specific learning regarding the potential inaccuracy of the content and/or automatically dis-incorporating the wiki-based content from the e-learning opportunity itself. These teachings can be optionally augmented to further provide a shared audit capability to facilitate a review of user interaction with both the wiki-based candidate training content and the learning opportunities. This can comprise, for example, gathering, organizing, and/or storing information regarding the identity of persons who have accessed a particular posting, who have contributed to a particular posting, the specifics of such interactions, and so forth.

Such a capability can be used, for example, to correlate feedback regarding a contribution of a given user with respect to a particular one of the wiki-based candidate training content items and/or the learning opportunities to facilitate the taking of at least one responsive action. For example, when the feedback comprises negative feedback, this responsive action can comprise automatically facilitating a review of other contributions as have been provided by the given user in order to determine the veracity and value of those other contributions. If desired, one may augment the use of such an audit capability by providing a corresponding capability to selectively restrict use of the audit capability. This might comprise, for example, permitting only a particular administrative user, or some select category or level of user, to use such an audit capability.

So configured, those skilled in the art will understand and appreciate that a wiki-based front end can serve to facilitate the generation of training content that a more traditional approach would either fail to generate or that would achieve only via a considerably longer period of development. These teachings ease and facilitate the vetting of such content and the incorporation of such content into a managed learning context where use of that content becomes controlled and tracked in an auditable manner. These teachings will also readily accommodate a cradle-to-grave approach that can accommodate both the incorporation of such content in a managed learning context as well as facilitating the re-vetting and/or reworking of that content or the retirement of that content from such usage.

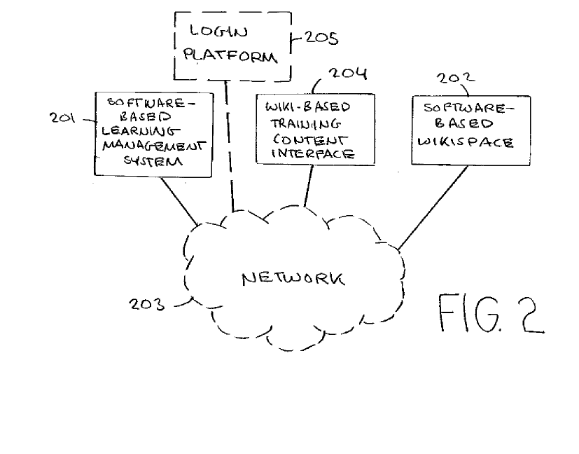

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 2, an illustrative approach to such a platform will now be provided.

In this illustrative example, a software-based learning management system 201 operably couples to a software-based wikispace 202 via an intervening network 203 (which may comprise an intranet or an extranet (such as the Internet) of choice). These systems can be configured and arranged to operate as described above (via, for example, corresponding programming as will be well understood by those skilled in the art). A wiki-based training content interface 204 can then be further operably coupled as shown to automatically facilitate incorporation of wiki-based candidate training content as a learning management system e-learning opportunity as described above. By one approach, if desired, such integration can be effected by using corresponding plug-ins that are introduced into the wikispace program to render that program more aware of the learning management system.

As is also mentioned above, these systems can share a common login process if desired. To accommodate such an optional capability, a login platform 205 can also be provided as shown.

Those skilled in the art will recognize and understand that such a system may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art.

These teachings are readily leveraged to facilitate bridging a gap that presently exists in many instances between learning management on the one hand and knowledge management on the other hand. Those skilled in the art will recognize and appreciate the significant extent to which these teachings permit leveraging of the collaborative power and growing familiarity with and ubiquity of wiki settings for the benefit of a centrally controlled and managed learning management system that would otherwise appear to be conceptually contrary to the wiki mindset and practice.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, by one approach, compensation can be provided to the authors and substantive contributors of content that becomes accepted as training content. Such compensation might comprise a flat amount or might, for example, relate to a duration of time during which the content finds use as actual training content. As another example, these teachings will accommodate creating links between e-learning opportunities and wikispace content even when the wikispace content does not comprise fully vetted candidate training content or even when the wikispace content has been identified as content that is not to be used as an e-learning opportunity per se. This can be done, for example, by placing links to such wikispace content in the e-learning opportunity material itself (as, for example, optional reading, recommended reading, or the like). Such an approach might be used, if desired, as a part of the vetting process for an item of candidate training content. In this case, specific learners who access such content from an e-learning opportunity could be further surveyed, audited, or tested to assess the value of the wikispace candidate training content and hence to judge the merits of including that candidate training content directly in an e-learning opportunity. The opposite could also be done, of course, by providing links to e-learning opportunities in wikispace content to alert the reader that such opportunities exist.

We claim:

1. A method comprising:
providing a software-based learning management system that maintains and offers defined learning paths and auditable training histories that correspond to learning opportunities for specific learners;
providing a software-based wikispace that is configured and arranged to permit substantially all visitors to create, edit, and publicly post candidate training content without preauthorization as to content;
allowing the specific learners to access the wikispace to thereby facilitate development of wiki-based candidate training content;
automatically facilitating incorporation of the wiki-based candidate training content as at least one of the learning opportunities.

2. The method of claim 1 wherein the specific learners are affiliated with a shared enterprise.

3. The method of claim 2 wherein the shared enterprise comprises at least one of:
a business;
a non-profit enterprise;
an academic institution;
a shared affinity organization
a union.

4. The method of claim 1 wherein providing a software-based wikispace comprises providing a browser-based visitor interface.

5. The method of claim 1 wherein providing a software-based wikispace that is configured and arranged to permit substantially all visitors to create, edit, and publicly post candidate training content without preauthorization as to content further comprises providing a software-based wikispace that is configured and arranged to permit substantially all visitors to delete previously posted candidate training content.

6. The method of claim 1 wherein allowing the specific learners to access the wikispace comprises allowing the specific learners to access the wikispace without requiring a login process that is separate and discrete from a login process that is required to gain access to the learning management system.

7. The method of claim 1 wherein automatically facilitating incorporation of the wiki-based candidate training content as at least one of the learning opportunities comprises, at least in part, providing an opportunity to characterize a given item of wiki-based candidate training content as being trackable.

8. The method of claim 7 wherein automatically facilitating incorporation of the wiki-based candidate training content as at least one of the learning opportunities further comprises automatically adding a given item of wiki-based candidate training content that has been characterized as being trackable to at least one defined learning path.

9. The method of claim 1 wherein automatically facilitating incorporation of the wiki-based candidate training content as at least one of the learning opportunities comprises providing an opportunity to a person other than a specific learner who contributed to a given item of wiki-based candidate training content to authorize inclusion of the given item of wiki-based candidate training content in at least one defined learning path.

10. The method of claim 9 wherein automatically facilitating incorporation of the wiki-based candidate training content as at least one of the learning opportunities further comprises automatically providing a notice to specific learners who are associated with the at least one defined learning path of the given item of wiki-based candidate training content.

11. The method of claim 9 wherein automatically facilitating incorporation of the wiki-based candidate training content as at least one of the learning opportunities further comprises using the learning management system to track usage of the given item of wiki-based candidate training content by specific learners.

12. The method of claim 1 wherein automatically facilitating incorporation of the wiki-based candidate training content as at least one of the learning opportunities further comprises automatically facilitating incorporation of the wiki-based candidate training content as a required component of at least one of the learning opportunities for at least some of the specific learners.

13. The method of claim 1 further comprising:
automatically notifying a supervisor of at least one of the specific learners when the at least one of the specific learners contributes content to the wiki-based candidate training content.

14. The method of claim 13 wherein automatically notifying the supervisor comprises, at least in part, providing information regarding an identity of the at least one of the specific learners and information to facilitate reviewing the content contributed by the at least one of the specific learners.

15. The method of claim 1 further comprising:
establishing a time frame during which the wiki-based candidate training content as has been incorporated into at least one of the learning opportunities must be reviewed for accuracy.

16. The method of claim 15 further comprising;
automatically monitoring for review of the wiki-based candidate training content that has been incorporated into at least one of the learning opportunities;
when the review does not occur within the time frame, automatically downgrading incorporation of the wiki-based candidate learning content into the at least one learning opportunity.

17. The method of claim 16 wherein the downgrading comprises at least one of:
providing a notice in conjunction with presentation of the wiki-based candidate learning content regarding potential inaccuracy of the wiki-based candidate learning content;
automatically dis-incorporating the wiki-based candidate learning content from the at least one learning opportunity.

18. The method of claim 1 further comprising:
identifying life-cycle categories as pertain at least to wiki-based candidate training content that becomes incorporated as at least one of the learning opportunities;
providing at least one rule that correlates to a given one of the life-cycle categories.

19. The method of claim 18 wherein the at least one rule comprises at least one action to be taken upon attainment of the given one of the life-cycle categories.

20. The method of claim 19 wherein the at least one action comprises an action to be automatically taken.

21. The method of claim 1 further comprising:
providing an audit capability to facilitate a review of user interaction with at least one of the wiki-based candidate training content and the learning opportunities.

22. The method of claim 21 wherein providing an audit capability to facilitate a review of user interaction with at least one of the wiki-based candidate training content and the learning opportunities further comprises providing a shared audit capability to facilitate a review of user interaction with both the wiki-based candidate training content and the learning opportunities.

23. The method of claim 21 further comprising:
correlating feedback regarding a contribution of a given user with respect to a particular one of the at least one of the wiki-based candidate training content and the learning opportunities to facilitate the taking of at least one responsive action.

24. The method of claim 23 wherein the at least one responsive action comprises, when the feedback comprises negative feedback, facilitating a review of other contributions as have been provided by the given user.

25. The method of claim 21 further comprising:
providing a capability to selectively restrict use of the audit capability.

26. The method of claim 21 wherein providing a software-based wikispace further comprises providing a software-based wikispace that is configured and arranged to automatically search at least one external resource to attempt to identify additional content that may be relevant to the publicly posted candidate training content.

27. The method of claim 26 wherein the external resource comprises the Internet.

28. The method of claim 26 wherein providing a software-based wikispace further comprises providing a software-based wikispace that is configured and arranged to automatically provide information regarding the additional content in conjunction with posting of the candidate training content.

29. The method of claim 28 wherein automatically provide information regarding the additional content comprises posting the information in an order that corresponds to a particular sorting criteria.

30. The method of claim 29 wherein the particular sorting criteria relates to at least one of age, alphabetizing, author, a corresponding rating, and an original publisher of the information.

31. The method of claim 1 further comprising:
providing a link in at least one of the learning opportunities that directs a specific learner to content in the wikispace that is not necessarily candidate training content.

32. An apparatus comprising:
a software-based learning management system that maintains and offers defined learning paths and auditable training histories that correspond to learning opportunities for specific learners;
a software-based wikispace that is configured and arranged to permit substantially all visitors to create, edit, and publicly post candidate training content without preauthorization as to content, wherein the wikispace is operably coupled to the learning management system such that the specific learners can access the wikispace to thereby facilitate development of wiki-based candidate training content;
a wiki-based training content interface that is configured and arranged to automatically facilitate incorporating the wiki-based candidate training content as at least one of the learning opportunities.

33. The apparatus of claim 32 wherein the specific learners are affiliated with a shared enterprise.

34. The apparatus of claim 33 wherein the shared enterprise comprises at least one of:
a business;
a non-profit enterprise;
an academic institution;
a shared affinity organization;
a union.

35. The apparatus of claim 32 wherein the software-based wikispace comprises a browser-based visitor interface.

36. The apparatus of claim 32 wherein the software-based wikispace is further configured and arranged to permit substantially all visitors to delete previously posted candidate training content.

37. The apparatus of claim 32 further comprising a login platform that is configured and arranged to allow the specific learners to access both the wikispace and the learning management system using a shared login process.

38. The apparatus of claim 32 further comprising means for permitting a person other than a specific learner who contributed to a given item of wiki-based candidate training content to authorize inclusion of the given item of wiki-based candidate training content in at least one defined learning path.

39. The apparatus of claim 38 further comprising means for automatically providing a notice to specific learners who are associated with the at least one defined learning path of the given item of wiki-based candidate training content.
